(19) United States
(12) Patent Application Publication
(10) Pub. No.: US 2016/0227790 A9
(43) Pub. Date: Aug. 11, 2016

(54) COMPOSITIONS AND METHOD OF CONTROLLING FUNGUS

(71) Applicant: FBSCIENCES HOLDINGS, INC., Collierville, TN (US)

(72) Inventors: Terry J. Hanson, Raleigh, NC (US); Kenneth Scott Day, Clovis, CA (US); John Bradley, Collierville, TN (US)

(21) Appl. No.: 14/428,181

(22) PCT Filed: Sep. 13, 2013
(86) PCT No.: PCT/US13/59681

§ 371 Date: Mar. 13, 2015

Related U.S. Application Data
(60) Provisional application No. 61/700,619, filed on Sep. 13, 2012.

(51) Int. Cl. A01N 65/00

(52) U.S. Cl. CPC A01N 65/00

(57) ABSTRACT

Compositions and methods of phytopathogenic fungus control are provided, the compositions and methods include a first component of dissolved organic matter (DOM) concentrate having natural organic matter of defined composition, suitable for soil, foliar, and seed coating.

### TECHNICAL FIELD

Disclosed are compositions and methods for management of fungus or fungus-like organisms. In specific embodiments, methods for management of phytopathogenic fungus in soils and agricultural environments, seeds and foliage is disclosed. Specifically, the compositions and methods comprises contacting a locus of a seed or plant with a dissolved organic matter (DOM) concentrate having natural organic matter of defined composition.

### BACKGROUND

Many phytopathogenic fungi are known to affect the yield, growth, and health of crops and plants. Phytopathogenic fungi generally are soil-borne and foliar organisms that affect the root system, foliage, fruits, and other plant parts, resulting in physiological changes to the plant. Plant functions essential to health can stop completely or be compromised resulting in an inadequate supply of water and nutrients, causing foliage chlorosis and/or wilt, as well as stunting of growth, any of which can result in low yield or death. Plant-deleterious fungi can destroy plant foliage reducing photosynthetic capacity as well as directly attack the fruits of the plant. Crops affected by certain fungi can also lose their marketability because of the non-aesthetic appearance of fungi or colonies caused by the fungus.

In addition, fungi can cause physiological effects leading to an increase in the susceptibility of plant roots to bacteria and/or pest attack, including bacteria and/or pest the plant would otherwise resist. Such attack can lead to extensive secondary decay and rotting.

Current treatments for fungi population control typically include chemicals, biologicals, and/or non-chemical methods such as Systemic Acquired Resistance Inducers to provide resistant crop strains, GMO's, and Inhibitors to clear loci prior to planting. Each of the above chemical and biological classes of compounds and methods have one or more drawbacks, including, but not limited to, toxicity, cost, availability, reliability, and high application amounts. New fungicides face elevated government regulations and public scrutiny as to their environmental and ecological impact.

While there are thousands of fungi species, certain genera of fungus have a far greater negative economic impact on agriculture than others. While it is difficult to isolate the effect of one fungus in an ecological system, the estimated overall average yearly yield loss due to fungus is estimated in the billions of dollars.

### SUMMARY

There is now provided a method for management of phytopathogenic fungus or fungus-like organism on a seed, plant, or locus of a seed or a plant. The method comprising preparing a seed with, or introducing to a plant or its locus, an amount of dissolved organic matter (DOM) concentrate of natural organic matter of defined composition. The method reducing or eliminating damage to the seed or plant caused directly or indirectly from the phytopathogenic fungus. In one aspect, the partially humified organic material characterized by at least two of: a mixture of condensed hydrocarbons, lignins, and tannins and/or condensed tannins, and one or more trace metals; an oxygen-to-carbon ratio for the dissolved organic matter of greater than about 0.5; a total number of tannin compounds greater than about 200, the tannin compounds having a hydrogen to carbon ration of about 0.5 to about 1.4, and an aromaticity index of less than about 0.7 as measured by mass spectroscopy; or a percent mass distribution of about 47-56 percent lignin compounds, 33-42 percent tannin compounds, and about 8-11 percent condensed hydrocarbon as measured by mass spectroscopy. In another aspect, the dissolved organic matter (DOM) concentrate is essentially metal cation free.

In another embodiment, method of controlling a fungus, a fungus-like organism, or a yeast in an environment is provided. The method comprising introducing to the environment an amount of dissolved organic matter (DOM) concentrate of natural organic matter of defined composition. In one aspect, the environment is lumber, wood-based materials, aqueous compositions comprising cellulosic material, or aqueous-based paint. In another aspect, the dissolved organic matter (DOM) concentrate is essentially metal cation free.

In another embodiment, the use of a dissolved organic matter (DOM) concentrate of defined composition for reducing or eliminating damage to a seed or plant caused directly or indirectly from a phytopathogenic fungus is provided. The DOM characterized by at least two of: an oxygen-to-carbon ratio for the dissolved organic matter of greater than about 0.5; a total number of tannin compounds greater than about 200, the tannin compounds having a hydrogen to carbon ration of about 0.5 to about 1.4, and an aromaticity index of less than about 0.7 as measured by mass spectroscopy; or a percent mass distribution of about 47-56 percent lignin compounds, 33-42 percent tannin compounds, and about 8-11 percent condensed hydrocarbon as measured by mass spectroscopy.

### DETAILED DESCRIPTION

Disclosed and described herein is, in part, phytopathogenic fungi population control methods comprising the use of an isolated and optionally concentrated natural organic material of defined composition, hereinafter also referred to as the first component. At least one optional component comprising at least one pesticide (individually or collectively, an insecticide, a nematicide, a bactericide, an anti-viral) and/or, plant nutrient, or combinations thereof, can be employed in combination or in synergistic combination with the first component. Compositions disclosed and described herein vary depending on the intended method of application, the soil composition, existing fungus populations present, fungi species to which population is to be controlled, growing conditions, weather conditions, and seasonal timing of the plants, as well as other factors.

The term “agriculturally acceptable” applied to a material or composition herein means not unacceptably damaging or toxic to a plant or its environment, and not unsafe to the user or others that may be exposed to the material when used as described herein.

The term “control” or “controlling” or “management” are used interchangeably as used herein with specific reference to one or more phytopathogenic fungus is inclusive of preventing colonization, reducing existing colonization density, maintaining existing colonization density, killing, disrupting one or more life cycles, repelling, and combinations thereof. Control can include an insignificant amount of phytopathogenic fungus “death” yet provide a significant amount of seed and/or plant protection in an environment populated with phytopathogenic fungi. In certain aspects, the control of the phytopathogenic fungus is a result of a synergy caused by the contact of the first component with the seed and/or plant defense system, where repelling and/or toxicity of the phytopathogenic fungus is at least in part caused by the defense system of the seed and/or plant augmented by the first component. In other aspects, control includes providing the seed and/or plant improved plant health such that regardless of attack and/or damage by the phytopathogenic fungus, improvement in one or more of yield, height, weight, root infection, or stress resistance of a seed and/or plant is provided compared with untreated seed and/or plant under similar conditions. In other aspects, control includes providing the seed and/or plant improved plant health such that agronomical beneficial ectomycorrhizae and endomycorrhizae mycorrhizal associations are not substantially effected. Such mycorrhizal associations being inclusive of vesicular arbuscular (VA) mycorrhizae, for example, in alfalfa, beans, cassava, corn, dryland rice, potatoes, sugar cane, and wheat, etc.

The phrase “foliar surface” herein is inclusive of a leaf surface and other green parts of plants having surfaces that may permit absorption of active ingredient, including petioles, stipules, stems, bracts, flowerbuds, etc., and for present purposes “foliar surfaces” will be understood to include surfaces of such green parts.

The term “granular” and the phrase “granular form” as used herein, refers to granules, particulates, beads, microencapsulation, and combinations thereof. For example, granular forms are those suitable for dispensing equipment commonly used in an agricultural setting. Granular forms may be of any shape or size suitable for use in an agricultural setting or in agricultural equipment.

The term “locus” as used herein is inclusive of a foliar surface and also includes an area in proximity to a plant or the area in which a plurality of seed is or can be sown.

The term “seed” as used herein, is not limited to any particular type of seed and can refer to seed from a single plant species, a mixture of seed from multiple plant species, or a seed blend from various strains within a plant species. The disclosed and described compositions can be utilized to treat gymnosperm seed, dicotyledonous angiosperm seed and monocotyledonous angiosperm seed.

The phrase “seed treatment” as used herein refers generally to contacting a seed with a compound or composition of matter containing or comprising at least one active ingredient (a.i. or Al). The compound or composition of matter may be in any form suitable to the seed, for example, liquid, gel, emulsion, suspension, dispersion, spray, or powder. Seed treatment is inclusive of seed coating and seed dressing.

“Seed coating” or “seed dressing” as used herein are used interchangeably and refer generally to a coating or matrix formed on at least part of the seed, the coating or matrix comprising at least one Al. Optional compounds or agents may be included in the seed coating to facilitate the seed coating process or the disintegration/releasing of the at least one Al from the coating, or to prevent excessive dust-off or to add color to the treated seed. Seed coating includes, alone or in combination, seed buildup, seed encrustment, and seed pelleting operations. Seed coating can be on live or dead seeds.

Compositions comprising the first component and optional additional components disclosed and described herein can take the form of aqueous solutions, oil-in-water emulsions, or water-in-oil emulsions, dispersions, powders, seed coatings, or polymer-containing coatings.

The first component is suitable as a fungicide, distinguished by activity against phytopathogenic fungi, for example, from the class of the Ascomycetes, Deuteromycetes, Basidiomycetes, and Oomycetes. The first component is systemically effective and can be used in crop protection as a foliar fungicide, as fungicide for seed dressing, and as a soil fungicide, alone or in combination with other optional active components. The first component is useful in the control of fungi on various agronomically important crop plants, and genetically engineered crops that are tolerant to attack by insects or fungi or to herbicide applications.

The first component is suitable, alone or in synergistic combination with optional components, by way of example, for controlling the following plant diseases: Alternaria species on vegetables, oilseed rape, sugar beet and fruit and rice, such as, for example, A. solani or A. alternata on potatoes and tomatoes; Aphanomyces species on sugar beet and vegetables; Ascochyta species on cereals and vegetables; Bipolaris and Drechslera species on corn, cereals, rice and lawns, such as, for example, “Powdery Mildew,” e.g., D. maydis on corn, Blumeria graminis on cereals, Erysiphe graminis on barley, rye, Sphaerotheca xanthii on cucumber, muskmelon, pumpkin, Sphaerotheca macularis on strawberry, Uncinula necator on grape, and Oidiopsis sicula on tomato; Botrytis cinerea (gray mold) on strawberries, vegetables, flowers and grapevines; Bremia lactucae on lettuce; Cercospora species on corn, soybeans, rice and sugar beet; Cochliobolus species on corn, cereals, rice, such as, for example, Cochliobolus sativus on cereals, Cochliobolus miyabeanus on rice; Colletotricum species on soybeans and cotton; Pyrenophora species on corn, cereals, rice and lawns; Drechslera species, such as, for example, D. teres on barley or D. tritici-repentis on wheat; Esca on grapevines; Exserohilum species on corn; Erysiphe cichoracearum and Sphaerotheca fuliginea on cucumber plants; Fusarium and Verticillium species on various plants, such as, for example, F. graminearum or F. culmorum on cereals or F. oxysporum for example, on tomatoes; Gaeumanomyces graminis on cereals; Gibberella species on cereals and rice (for example Gibberella fujikuroi on rice); Helminthosporium species on corn and rice; Michrodochium nivale on cereals; Mycosphaerella species on cereals, bananas and groundnuts, such as, for example, M. graminicola on wheat or M. fijiensis on bananas; Peronospora species on cabbage and bulbous plants, such as, for example, P. brassicae on cabbage or P. destructor on onion; Phakopsara pachyrhizi and Phakopsara meibomiae on soybeans; Phomopsis species on soybeans and sunflowers; Phytophthora infestans on potatoes and tomatoes; Phytophthora species on various plants, such as, for example, P. capsici on bell pepper; Plasmopara viticola on grapevines; Podosphaera leucotricha on apple; Pseudocercosporella herpotrichoides on cereals; Pseudoperonospora on various plants, such as, for example, P. cubensis on cucumber or P. humili on hops; Puccinia species on various plants, such as, for example, P. triticina, P. striformins, P. hordei or P. graminis on cereals or P. asparagi on asparagus; Pyricularia oryzae, Corticium sasakii, Sarocladium oryzae, S. attenuatum, Entyloma oryzae on rice; Pyricularia grisea on lawns and cereals; Pythium spp. on lawns, rice, corn, cotton, oilseed rape, sunflowers, sugar beet, vegetables and other plants, such as, for example, P. ultiumum on various plants, P. aphanidermatum on lawns; Rhizoctonia species on cotton, rice, potatoes, lawns, corn, oilseed rape, potatoes, sugar beet, vegetables and on various plants, such as, for example, R. solani on beet and various plants; Rhynchosporium secalis on barley, rye and triticale; Sclerotinia species on oilseed rape and sunflowers; Sclerotium on various legume crops like soybeans and vegetable crops like tomato; Septoria on vegetables; Septoria tritici and Stagonospora nodorum on wheat; Erysiphe (syn. Uncinula) necator on grapevines; Setospaeria species on corn and lawns; Sphacelotheca reilinia on corn; Thievaliopsis species on soybeans and cotton; Tilletia species on cereals; Ustilago species on cereals, corn and sugar cane, such as, for example, U. maydis on corn; Venturia species (scab) on apples and pears, such as, for example, V. inaequalis on apple.

The first component is particularly suitable for controlling phytopathogenic fungi-like organisms from the class of the Peronosporomycetes (syn. Oomycetes), such as Peronospora species, Phytophthora species, Plasmopara viticola, Pseudoperonospora species and Pythium species.

The first component can also be used in non-agrochemical applications for example, in the protection of materials (for example wood, paper, paint dispersions, fibers or fabrics) and in the protection of stored products by controlling harmful fungi. For example, the first component can be applied to lumber, wood-based materials, or aqueous compositions comprising cellulosic material, etc., for the control of Ascomycetes, such as Ophiostoma spp., Ceratocystis spp., Aureobasidium pullulans, Sclerophoma spp., Chaetomium spp., Humicola spp., Petriella spp., Trichurus spp.; Basidiomycetes, such as Coniophora spp., Coriolus spp., Gloeophyllum spp., Lentinus spp., Pleurotus spp., Poria spp., Serpula spp. and Tyromyces spp., Deuteromycetes, such as Aspergillus spp., Cladosporium spp., Penicillium spp., Trichoderma spp., Alternaria spp., Paecilomyces spp. and Zygomycetes, such as Mucor spp. The first component can be used for in the protection of materials from the following yeasts: Candida spp. and Saccharomyces cerevisae.

In one aspect, the first component comprises a mixture of organic molecules isolated and extracted from sources rich in natural organic matter into an aqueous solution. The natural organic matter is primarily derived from plant materials that have been modified to varying degrees over time in a soil environment. Some of the plant materials have been recently deposited in the environment. At least a part of the natural organic matter has passed through a partial process of humification to become partially humified natural organic matter of defined composition. Humification includes microbial, fungal, and/or environmental (heat, pressure, sunlight, lightning, fire, etc.) degradation and/or oxidation of natural organic matter. Most preferably, the first component contains natural organic matter that has not substantially undergone humification (partially humified natural organic matter).

In one aspect, the natural organic matter is obtained from environments typically containing or providing anywhere between about 5 ppm, to about 500 ppm of dissolved organic matter (DOM). In other aspects, the natural organic matter is obtained from environments typically containing or providing between about 500 ppm to about 3000 ppm or more DOM. Most preferably, the composition of matter contains natural organic matter that has not substantially undergone humification (partially humified natural organic matter). In one aspect, the natural organic matter is obtained from environments typically containing or providing 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 95 ppm, 100 ppm, or up to 500 ppm of dissolved organic matter (DOM). In other aspects, the natural organic matter is obtained from environments typically containing or providing about 500 ppm, 1000 ppm, 1500 ppm, 2000 ppm, 2500 ppm, 3000 ppm or more DOM.

Natural organic matter is extremely complex, with thousands of compounds generally present, depending upon the source and the environmental conditions prevalent about the source. Humic substances such as Fulvic Acid (CAS No. 479-66-3) and Humic Acid (CAS No. 1415-93-6) are examples of organic complexes that are derived from natural organic matter, however, the first component is chemically and biologically unique from Fulvic and Humic acid, as detailed below.

The first component contains dissolved organic matter, the organic matter being formed during the process of humification as described above, such as microbial, fungicidal, and/or environmental (heat, pressure, sunlight, lightning, fire, etc.) degradation processes. Other natural or synthetic natural organic matter degradation processes may be involved or may be used. In one aspect, the first component contains predominately natural organic matter that has not undergone substantial humification (e.g., partially humified natural organic matter). The amount of humification may be determined and characterized using known methods, for example, by 13C NMR using controls of fully or completely humified natural organic matter, such as humic substances standards from the International Humic Substances Society, for example, Leonardite Humic Acid (LHA), Pahokee Peat Humic Acid (PPHA), and Suwannee River Fulvic Acid II (SRFA).

In one aspect, the first component is a complex mixture of polymeric polyhydroxy acids (“CPPA”) that is obtained by removing a natural organic matter from its source, optionally processing, and/or concentrating to provide a CPPA composition having a dissolved organic matter (DOM) concentration level of about 10×, 25×, 50×, 100×, 200×, 300×, 400×, 500×, 600×, 700×, 800×, 900×, 1000×, 1500×, 2000×, 2500×, 3000×, 3500×, 4000×, 4500×, or 5000× relative to its original source. In another aspect, CPPA concentrations of dissolved organic matter (DOM) concentration level can be about 7500×, 10,000×, 15,000×, 20,000×, 25,000×, and up to 50,000×. CPPA compositions may be adjusted such that the concentration of DOM is between about 10 ppm to about 700,000 ppm. Preferably, CPPA may be adjusted such that the concentration of DOM is between about 1000 ppm to about 500,000 ppm. CPPA compositions may be adjusted to a DOM value represented by any ppm value between 1000 ppm and 50,000 ppm, inclusive of any ppm value in 500 ppm increments (e.g., 10,500 ppm, 11,000 ppm, 11,500 ppm, 12,000 ppm, etc.) in aqueous solution. Other DOM concentrations may be used, for example, an extremely concentrated composition of between about 75,000 ppm and about 750,000 ppm can be prepared. For example, a concentrate of about 30,000× that of the original source can contain about 550,000 ppm of DOM. In certain aspects, CPPA compositions are approximately between about 91 percent to about 99 percent water, the remaining organic material being primarily DOM with minor amounts of alkali-, alkali earth-, and transition metal salts. In yet other aspects, the DOM of the CPPA composition has been dried or lyophilized in a form suitable for reconstitution with an aqueous solution.

Prior to or subsequent to the processes described above, metal ions can be removed and/or additional metal ions can be added to the CPPA to provide a CPPA product that can be adjusted to a predetermined amount or ratio of metal ion to either of the NOM or to the DOM or the total organic carbon (TOC).

The first component is a complex mixture of substances, typically a heterogeneous mixture of compounds for which no single structural formula will suffice. Elemental and spectroscopic characterization of the first component differentiates it from most other humic-based organic complexes, such as Humic and Fulvic Acids, as further discussed below. Blending of individual batches of the first component may be performed to provide consistency and to compensate for the normal variations of a naturally-derived material.

Detailed chemical and biological testing has shown that the complex mixture of substances of the first component is a unique composition both in its biological effect on plants and its chemical composition compared to Humic and Fulvic acids.

### Characterization Methods for the First Component

The organic compounds making up the first component of the composition, can be characterized in a variety of ways (e.g., by molecular weight, distribution of carbon among different functional groups, relative elemental composition, amino acid content, carbohydrate content, etc.). In one aspect, the first component was characterized relative to known standards of humic-based substances.

For purposes of characterizing carbon distribution among different functional groups, suitable techniques include, without limitation, 13C-NMR, elemental analysis, Fourier transform ion cyclotron resonance mass spectroscopy (FTICR-MS) and Fourier transform infrared spectroscopy (FTIR). The chemical characterization of the first component and Humic substance standards were carried out using Electro spray Ionization Fourier Transform Ion Cyclotron Resonance Mass Spectroscopy (ESI-FTICR-MS), Fourier Transform Infrared Spectroscopy (FTIR) and elemental analysis for metals using ICP-AES, conducted by Huffman Laboratories, Inc. and the University of Washington.

Elemental, molecular weight, and spectroscopic characterization of the first component is consistent with an organic complex that consists primarily of lignin and tannin compounds (and mixtures of condensed and un-condensed tannin), condensed aromatics and trace amounts of lipid and inorganics. Thousands of compounds are present, with molecular weights ranging from 225 to 700 daltons, the majority of compounds having between about 10 to about 39 carbon atoms per molecule. The first component is generally composed of carbon, oxygen, and hydrogen, with small amounts of nitrogen, and sulfur. The first component may also contain potassium and iron at levels above about 5 weight percent.

The elemental composition of the dissolved solids typically present in the first component is given in Table A. If the organic compounds are separated from the inorganic elements, the elemental breakdown is: C 55 percent, H 4 percent, O 38 percent, N 1.8 percent, and S 2.2 percent.

TABLE A
Average Elemental Composition of dissolved solids in a
representative sampling of first component, based upon
average values from 10 different lots.

| Element | % |
|---|---|
| Carbon | 35.1 |
| Oxygen | 24.6 |
| Hydrogen | 2.5 |
| Sulfur | 2.1 |
| Nitrogen | 1.3 |
| Potassium | 27.3 |
| Iron | 6.1 |
| Calcium | 0.2 |
| Sodium | 0.2 |
| Phosphorous | 0.1 |
| Other | 0.5 |

Among the classes of organic compounds present in the first component, preliminary analysis generally revealed that there are lignin and tannin (mixture of condensed and un-condensed), condensed aromatics, unidentified substances and some lipids present. Each of these classes of compounds is further characterized by a rather narrow Mw range and number of carbons/molecule. The breakdown of the number and percentage of each of the various compound classes, their MW's and carbon atoms/molecule (Carbon Range) for a first representative sampling of the first component is given in Table B1.

TABLE B1
Compound Classes in the first component, along with size and
carbon ranges for compounds in each class. Based upon
composite of 3 different production batches. Results for
individual batches are very similar.

| Compound | # | % of | Size Range | Carbon |
|---|---|---|---|---|
| Class | Compounds | Total | (daltons) | Range |
| Lignin | 1139 | 57 | 226-700 | 11 to 39 |
| Tannin | 587 | 30 | 226-700 | 10 to 31 |
| Condensed | 220 | 11 | 238-698 | 13 to 37 |
| Aromatic | | | | |
| Lipid | 18 | 1 | 226-480 | 14 to 30 |
| Carbohydrate | 1 | 0 | 653 | 24 |
| Other | 23 | 1 | 241-651 | 12 to 33 |

A breakdown of the number and percentage of each of the various compound classes, their MW's and carbon atoms/molecule (Carbon Range) for a second representative sampling based upon an average of 3 different production batches for the first component is given in Table B2.

TABLE B2
Compound Classes in the first component, along with size and
carbon ranges for compounds in each class. Based upon average
of 3 different production batches. Results for individual
batches are very similar.

| | | Percent of | Size Range | Carbon |
|---|---|---|---|---|
| Compound Class | # Compounds | Total | (daltons) | Range |
| Lignin | 711 | 56 | 226-700 | 11 to 39 |
| Tannin | 410 | 33 | 226-700 | 10 to 31 |
| Condensed | 122 | 10 | 238-698 | 13 to 37 |
| Aromatic | | | | |
| Lipid | 12 | ~1 | 226-480 | 14 to 30 |
| Carbohydrate | 1 | 0 | 653 | 24 |
| Other | 14 | ~1 | 241-651 | 12 to 33 |

Table C, summarizes the oxygen-to-carbon (O/C) and hydrogen-to-carbon (H/C) ratios used in defining the classes described above.

TABLE C
Elemental Ratios and chemical classifications used in
characterizing samples of the first component.

| Class | O/C | H/C | Aromaticity Index |
|---|---|---|---|
| Lignin | 0.15-0.6 | 0.6-1.7 | <0.7 |
| Tannin | 0.6-1.0 | 0.5-1.4 | <0.7 |
| Condensed Aromatic | 0.1-0.7 | 0.3-0.7 | >0.7 |
| Lipid | 0-0.2 | 1.8-2.2 | |
| Carbohydrate | 0.6-1.0 | 1.8-2.2 | |

Comparison with Humic Substance Standards

Comparative elemental and structural characterization of Humic Substances verses samples of the first component were performed. Three humic substances standards from the International Humic Substances Society were used: Leonardite Humic Acid (LHA), Pahokee Peat Humic Acid (PPHA), and Suwannee River Fulvic Acid II (SRFA). Each humic substance standards and each sample of the first component was analyzed by FTIR and ESI-FTICR-MS. A portion of each humic substance standard was dissolved in water/methanol, with ammonium ions added for ionization enhancement, for the ESI-FTICR-MS analysis. Three samples of the first component (#1, #2, and #3) were prepared for analysis with cation exchange resin (AG MP-50, Bio-Rad Laboratories, Hercules, Calif.). Comparison of the Humic Substance standards and each sample of the first component is presented in Table D.

TABLE D
Comparison of humic substance standards with three samples of
the first component. Table D indicates that there are major
differences between the Humic Substances standards and the
samples representing the first component. For example, the O/C
ratio is less than 0.4 in all of the Humic Substances but is at
least 0.5 for the first component samples. The DBE for the
samples is also significantly lower than for the Humic Acid
Standards and the average MW is greater.

| Sample | O/C | H/C | DBE | Avg. MW |
|---|---|---|---|---|
| Suwannee River Fulvic Acid (SRFA) | 0.39 | 1.01 | 12.7 | 445.7 |
| Pahokee Peat Humic Acid (PPHA) | 0.34 | 0.75 | 16.29 | 429.8 |
| Leonardite Humic Acid (LHA) | 0.3 | 0.79 | 15.8 | 423.6 |
| #1 | 0.54 | 0.87 | 13.7 | 472.9 |
| #2 | 0.54 | 0.89 | 13.23 | 456.9 |
| #3 | 0.5 | 0.91 | 13.23 | 455.7 |

Based on mass spectral analysis, there are a number of compounds present in the first component samples that are substantially absent or greatly reduced in the Humic Substance standards. In particular, at least one component of the first component may correspond with one or more tannin compounds. By comparison, in the Humic Substance standards, the percent of tannin compounds are present in a small amount. For example, in the Fulvic Acid standard and in the Humic Acid standards, both standards are at least 3×-4× less than the percent tannins found in the first component samples, as shown in Table E.

TABLE E
Number and percent tannins in Humic Substance Standards
verses first component samples.

| | | percent of |
|---|---|---|
| Sample | # tannins | tannin compounds |
| Suwannee River Fulvic Acid (SRFA) | 192 | 8.8 |
| Pahokee Peat Humic Acid (PPHA) | 9 | 1.2 |
| Leonardite Humic Acid (LHA) | 22 | 1.2 |
| #1 | 441 | 35.2 |
| #2 | 357 | 34.6 |
| #3 | 432 | 28.3 |

Comparing the Fourier Transform Infrared (FTIR) spectra for the IHSS standards and first component samples, there are similarities, primarily in the region from 1600 to 1800 cm-1. In both sets of samples we see a very strong peak at around 1700 cm-1 due to the C═O stretch from a carboxyl functional group and a peak in the 1590 to 1630 region which is consistent with a C═C bond from alkenes or aromatics. However, significant differences in the region from 700 to 1450 cm-1 are observed. Peaks at 1160 to 1210 are present in all the spectra and are from the C—O bond of alcohols, ethers, esters and acids. The biggest difference is the peak at 870 cm-1 in the first component samples, which is absent in the IHSS standards. This peak may be due to the C—H bond of alkenes and aromatics. Based on the characterization data, the first component may contain relatively small molecules or supramolecular aggregates with a molecular weight distribution of about 300 to about 18,000 daltons or greater. Included in the organic matter from which the mixture of organic molecules are fractionated are various humic substances, organic acids and microbial exudates. The mixture is shown to have both aliphatic and aromatic characteristics. Illustratively, the carbon distribution shows about 35 percent in carbonyl and carboxyl groups; about 30 percent in aromatic groups; about 18 percent in aliphatic groups, about 7 percent in acetal groups; and about 12 percent in other heteroaliphatic groups.

In some embodiments, the mixture of compounds in the first component comprises organic molecules or supramolecular aggregates with a molecular weight distribution of about 300 to about 30,000 daltons, for example, about 300 to about 25,000 daltons, about 300 to about 20,000 daltons, or about 300 to about 18,000 daltons.

Characterizing carbon distribution among different functional groups, suitable techniques can be used, including without limitation, 13C-NMR, elemental analysis, Fourier transform ion cyclotron resonance mass spectroscopy (FTICR-MS) and Fourier transform infrared spectroscopy (FTIR).

In one aspect, carboxy and carbonyl groups together account for about 25 percent to about 40 percent, for example about 30 percent to about 37 percent, illustratively about 35 percent, of carbon atoms in the mixture of organic compounds of the first component.

In one embodiment, aromatic groups account for about 20 percent to about 45 percent, for example about 25 percent to about 40 percent or about 27 percent to about 35 percent, illustratively about 30 percent, of carbon atoms in the mixture of organic compounds of the first component.

In one embodiment, aliphatic groups account for about 10 percent to about 30 percent, for example about 13 percent to about 26 percent or about 15 percent to about 22 percent, illustratively about 18 percent, of carbon atoms in the mixture of organic compounds of the first component.

In one embodiment, acetal and other heteroaliphatic groups account for about 10 percent to about 30 percent, for example about 13 percent to about 26 percent or about 15 percent to about 22 percent, illustratively about 19 percent, of carbon atoms in the mixture of organic compounds of the first component.

In one aspect, the ratio of aromatic to aliphatic carbon is about 2:3 to about 4:1, for example about 1:1 to about 3:1 or about 3:2 to about 2:1 in the first component.

In a particular illustrative aspect, carbon distribution in the mixture of organic compounds of the first component is as follows: carboxy and carbonyl groups, about 35 percent; aromatic groups, about 30 percent; aliphatic groups, about 18 percent, acetal groups, about 7 percent; and other heteroaliphatic groups, about 12 percent.

Elemental composition of the organic compounds of the first component is independently in one series of embodiments as follows, by weight: C, about 28 percent to about 55 percent, illustratively about 38 percent; H, about 3 percent to about 5 percent, illustratively about 4 percent; 0, about 30 percent to about 50 percent, illustratively about 40 percent; N, about 0.2 percent to about 3 percent, illustratively about 1.5 percent; S, about 0.2 percent to about 4 percent, illustratively about 2 percent.

Elemental composition of the organic compounds of the first component is independently in another series of embodiments as follows, by weight: C, about 45 percent to about 55 percent, illustratively about 50 percent; H, about 3 percent to about 5 percent, illustratively about 4 percent; 0, about 40 percent to about 50 percent, illustratively about 45 percent; N, about 0.2 percent to about 1 percent, illustratively about 0.5 percent; S, about 0.2 percent to about 0.7 percent, illustratively about 0.4 percent.

In a particular illustrative aspect, elemental distribution is, by weight: C, about 38 percent; H, about 4 percent; 0, about 40 percent; N, about 1.5 percent; and S, about 2 percent. The balance consists mainly of inorganic ions, principally potassium and iron in the first component.

In another particular illustrative aspect, elemental distribution is, by weight: C, about 50 percent; H, about 4 percent; 0, about 45 percent; N, about 0.5 percent; and S, about 0.4 percent in the first component.

Among classes of organic compounds that can also be present in the first component are, in various aspects, amino acids, carbohydrates (monosaccharides, disaccharides and polysaccharides), sugar alcohols, carbonyl compounds, polyamines, lipids, and mixtures thereof. These specific compounds typically are present in minor amounts, for example, less than 5 percent of the total percent of compounds.

Examples of amino acids that can be present include without limitation arginine, aspartic acid, glutamic acid, glycine, histidine, isoleucine, serine, threonine, tyrosine and valine.

Examples of monosaccharide and disaccharide sugars that can be present include without limitation glucose, galactose, mannose, fructose, arabinose, ribose and xylose.

Based on the above chemical, elemental and structural characterization, the first component is chemically and biologically unique from Humic and Fulvic acids or combinations thereof. Further, as a result of the nature and extent of gene regulation and overall effect of the first component with respect to improved plant health, drought, salinity, and pest-stress resistance, it is generally believed that the first component is unique to that of known humic and/or fulvic acid compositions and treatments, for which such activity and properties are generally lacking in quality and quantity. Other beneficial plant function attributes of the first component may be present or result from gene regulation of the plant's natural defenses obtained from the first component and/or the ability of the first component to act as an effective nematicide.

A suitable mixture of organic compounds can be found in products marketed as Carbon Boost-S soil solution and KAFE™-F foliar solution (Floratine Biosciences, Inc., Collierville, Tenn.) the active ingredient having CAS Reg. No. 1175006-56-0.

In one aspect, a highly concentrated form of the first component comprising the DOM is preferred. The DOM concentrate can be diluted thereafter for application, e.g., for foliar or soil application. Alternatively, the DOM concentrate can be used “as-is” e.g., for seed coating applications, fertilizer coatings, or other non-agrochemical uses where control of fungus or fungus-like organisms is needed or required. The amount of the first component that should be present in the composition depends on the particular organic mixture used. The amount should not be so great as to result in a physically unstable composition, for example by exceeding the limit of solubility of the mixture in the composition, or by causing other essential components to fall out of solution. On the other hand, the amount should not be so little as to fail to provide control of phytopathogenic fungus control or enhanced disease protection when applied to a target plant species or its loci.

In one aspect, the first component is obtained by removing a natural organic matter from its source, optionally processing, and/or concentrating to provide the first component having a dissolved organic matter (DOM) concentration level of from anywhere between about 10× to about 5000× relative to its original source concentration. In another aspect, the first component concentrations of dissolved organic matter (DOM) concentration level can be between about 7500× up to about 50,000×. The first component may be adjusted such that the concentration of DOM is between about 10 ppm to about 700,000 ppm. Preferably, the first component may be adjusted such that the concentration of DOM is between about 1000 ppm to about 500,000 ppm. The first component may be adjusted to a DOM value represented by any ppm value between 1000 ppm and 50,000 ppm, inclusive of any ppm value in 500 ppm increments (e.g., 10,500 ppm, 11,000 ppm, 11,500 ppm, 12,000 ppm, etc.) in aqueous solution. Other DOM concentrations may be used, for example, an extremely concentrated composition of between about 75,000 ppm and about 750,000 ppm can be prepared. For example, a concentrate of about 30,000× of the original source can contain about 550,000 ppm of DOM. In certain aspects, the first component are approximately between about 91 percent to about 99 percent water, the remaining organic material being primarily DOM with minor amounts of alkali-, alkali earth-, and transition metal salts. In yet other aspects, the DOM of the first component has been dried or lyophilized in a form suitable for reconstitution with an aqueous solution.

Optionally, additional components, e.g., second component can be present in a composition of the present disclosure together with the first component as describe above. For example, the composition can further comprise as an optional component, at least one agriculturally acceptable pesticide. Additional sources of these nutrients can be present, if desired. Examples of other plant nutrients, sources of which can optionally be included, are potassium (K), and sulfur (S), phosphorus (P), calcium (Ca), magnesium (Mg), iron (Fe), zinc (Zn), manganese (Mn), copper (Cu) and boron (B).

Advantageously, multivalent cations such as Ca⁺², Mg⁺², Mn⁺², or Fe^{+2/3} can be added to an aqueous composition containing the first component. The first component, and at least some of its mixture of compounds, are generally known to complex with one or more multivalent cations such as Ca, Mg, Mn, or Fe, such complexes can substantially improve the efficacy of the first component and/or maintain the potency of the second component (e.g., pesticide) compared to a solution comprising the multivalent cations and pesticide in the absence of the first component.

Advantageously, removal of multivalent cations such as Ca⁺², Mg⁺², Mn⁺², Zn⁺², Mo⁺², or Fe^{+2/3} can be performed on the first component using cation-exchange techniques to provide an essentially “metal cation-free” DOM concentrate. The first component, and at least some of its mixture of compounds, are generally known to complex with one or more multivalent metal cations such as calcium (Ca), zinc (Zn), magnesium (Mg), manganese (Mn), molybdenum (Mo), and/or iron (Fe), as well as other transition metals (e.g., nickel, copper, etc.) and when contacted with a phytopathogenic fungus, such metal cation-free DOM concentrate comprising compositions can substantially improve the efficacy of the first component in controlling the phytopathogenic fungus population, (and/or maintain or synergistically improve the potency of the second component (e.g., another fungicide) compared to a similar composition comprising the multivalent cations and pesticide with the first component or in the absence of the first component. While not to be held to any particular theory, it is believed that an essentially “metal cation-free” DOM concentrate can disrupt one or more metal cation-dependent biological pathways of the fungus or fungus-like organism and therefore reduce or eliminate damage to a seed or a plant caused directly or indirectly from the fungus or fungus-like organism.

Other ingredients can optionally be present in a composition disclosed and described herein, including such conventional formulation adjuvants as surfactants (for example to enhance wetting of seed or foliar surfaces), antifoam agents, spray drift controlling agents, viscosity modulating agents, antifreezes, coloring agents, penetrates, etc. Any of these can be added if desired, so long as they do not destabilize essential components of the composition.

Processes for preparing a composition disclosed and described herein typically involve simple admixture of the required ingredients. If desired, any of the ingredients can be pre-dissolved in a suitable volume of water before mixing with other ingredients. Order of addition is not generally critical.

### Second Component

An optional second component can be employed, which can be at least one of a pesticide, where the term “pesticide” herein refers to at least one of bactericides, other fungicides, insecticides (including acaricides and other nematicides), attractants, sterilizing agents, growth-regulating substances, herbicides, safeners, fertilizers, or semiochemicals. Examples of optional second components are provided below.

Bactericides: Bronopol, dichlorophen, nitrapyrin, nickel dimethyl dithiocarbamate, kasugamycin, octhilinone, furancarboxylic acid, oxytetracycline, probenazole, streptomycin, tecloftalam, copper sulphate and other copper preparations. Such combination of first component and bactericide can be synergistic with regard to the combination of chemical constituents, and/or, synergistic with regard to ability of the first component and/or bactericide to improve and/or enhance the natural defenses of a plant against bacterial attack and/or stresses directly or indirectly caused by such bacterial attack.

In another aspect, the second component is, for example: Inhibitors of Nucleic Acid Synthesis for example, benalaxyl, benalaxyl-M, bupirimate, chiralaxyl, clozylacon, dimethirimol, ethirimol, furalaxyl, hymexazol, metalaxyl, metalaxyl-M, ofurace, oxadixyl, oxolinic acid; Inhibitors of Mitosis and Cell Division for example, benomyl, carbendazim, diethofencarb, fuberidazole, pencycuron, thiabendazole, thiophanate-methyl, zoxamide; Inhibitors of Respiratory Chain Complex I for example, diflumetorim; Inhibitors of Respiratory Chain Complex II for example, boscalid, carboxin, fenfuram, flutolanil, furametpyr, mepronil, oxycarboxin, penthiopyrad, thifluzamide; Inhibitors of Respiratory Chain Complex III for example, azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin Decouplers dinocap, fluazinam; Inhibitors of ATP Production for example, fentin acetate, fentin chloride, fentin hydroxide, silthiofam; Inhibitors of Amino Acid Biosynthesis and Protein Biosynthesis for example, andoprim, blasticidin-S, cyprodinil, kasugamycin, kasugamycin hydrochloride hydrate, mepanipyrim, pyrimethanil; Inhibitors of Signal Transduction for example, fenpiclonil, fludioxonil, quinoxyfen; Inhibitors of Lipid and Membrane Synthesis for example, chlozolinate, iprodione, procymidone, vinclozolin ampropylfos, potassium-ampropylfos, edifenphos, iprobenfos (IBP), isoprothiolane, pyrazophos tolclofos-methyl, biphenyl iodocarb, propamocarb, propamocarb hydrochloride; Inhibitors of Ergosterol Biosynthesis for example, fenhexamid, azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazole, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidole, nuarimol, pyrifenox, triforine, pefurazoate, prochloraz, triflumizole, viniconazole, aldimorph, dodemorph, dodemorph acetate, fenpropimorph, tridemorph, fenpropidin, spiroxamine, naftifine, pyributicarb, terbinafine; Inhibitors of Cell Wall Synthesis for example, benthiavalicarb, bialaphos, dimethomorph, flumorph, iprovalicarb, polyoxins, polyoxorim, validamycin A; Inhibitors of Melanin Biosynthesis for example, carpropamid, diclocymet, fenoxanil, phthalide, pyroquilon, tricyclazole; Resistance Inductors for example, acibenzolar-S-methyl, probenazole, tiadinil Multisite captafol, captan, chlorothalonil, copper salts such as: copper hydroxide, copper naphthenate, copper oxychloride, copper sulphate, copper oxide, oxine-copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations containing calcium polysulphide, thiram, tolylfluanid, zineb, ziram; Actives of Unknown Mechanism for example, amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methyl sulphate, diphenylamine, ethaboxam, ferimzone, flumetover, flusulphamide, fluopicolide, fluoroimide, hexachlorobenzene, 8-hydroxyquinoline sulphate, irumamycin, methasulphocarb, metrafenone, methyl isothiocyanate, mildiomycin, natamycin, nickel dimethyl dithiocarbamate, nitrothal-isopropyl, octhilinone, oxamocarb, oxyfenthiin, pentachlorophenol and salts, 2-phenylphenol and salts, piperalin, propanosine-sodium, proquinazid, pyrrolnitrin, quintozene, tecloftalam, tecnazene, triazoxide, trichlamide, zarilamid and 2,3,5,6-tetrachloro-4-(methylsulphonyl)pyridine, N-(4-chloro-2-nitrophenyl)-N-ethyl-4-methylbenzenesulphonamide, 2-amino-4-methyl-N-phenyl-5-thiazolecarboxamide, 2-chloro-N-(2,3-dihydro-1,1,3-trimethyl-1H-inden-4-yl)-3-pyridinecarboxam-ide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl-4-[[[[1-[3-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-imidazole-5-carboxylate, 3,4,5-trichloro-2,6-pyridinedicarbonitrile, methyl 2-[[[cyclopropyl[(4-methoxyphenyl)imino]methyl]thio]methyl]-.alpha.-(meth-oxymethylene)benzacetate, 4-chloro-alpha-propynyloxy-N-[2-[3-methoxy-4-(2-propynyloxyl)phenyl]ethyl]-benzacetamide, (2S)—N-[2-[4-[[3-(4-chlorophenyl)-2-propynyl]oxy]-3-methoxyphenyl]ethyl]-3-methyl-2-[(methylsulphonyl)amino]butanamide, 5-chloro-7-(4-methylpiperidin-1-yl)-6-(2,4,6-trifluorophenyl) [1,2,4]-triazolo[1,5-a]pyrimidine, 5-chloro-6-(2,4,6-trifluorophenyl)-N-[(1R)-1,2,2-trimethylpropyl]-[1,2,4]-triazolo[1,5-a]pyrimidine-7-amine, 5-chloro-N-[(1R)-1,2-dimethylpropyl]-6-(2,4,6-trifluorophenyl)[1,2,4]tria-zolo[1,5-a]pyrimidine-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propylbenzopyranon-4-one, N-{(2)-[(cyclopropylmethoxy)-imino][6-(difluoromethoxy)-2,3-difluorophenyl]methyl}-2-benzacetamide, N-(3-ethyl-3,5,5-tri methylcyclohexyl)-3-formylamino-2-hydroxybenzamide, 2-[[[[1-[3-(1-fluoro-2-phenylethyl)oxy]phenyl]ethylidene]amino]oxy]methyl-]-alpha-(methoxyimino)-N-methyl-alphaE-benzacetamide, N-{2-[3-chloro-5-(trifluoromethyl)pyridin-2-yl]ethyl}-2-(trifluoromethyl)-benzamide, N-(3′,4′-dichloro-5-fluorobiphenyl-2-yl)-3-(difluoromethyl)-1-methyl-1H-pyrazole-4-carboxamide, N-(6-methoxy-3-pyridinyl)cyclopropanecarboxamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, 2-(2-{[6-(3-chloro-2-methylphenoxy)-5-fluoropyrimidin-4-yl]oxy}phenyl)-2-(methoxyimino)-N-methyl-acetamide, and/or combinations, e.g., fluxapyroxad and pyraclostrobin. Chitosan can be employed as the second component. Such combination of first component and second component listed above can be synergistic with regard to the combination of chemical constituents, and/or, synergistic with regard to ability of the first component and/or second to improve and/or enhance the natural defenses of a plant against parasitic attack and/or stresses directly or indirectly caused by such parasitic attack.

In another aspect, the first component is used together with an insecticide, for example: Acetylcholine Esterase (AChE) Inhibitors for example, carbamates, for example alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulphan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, triazamate; Acetylcholine Receptor Agonists/Antagonists for example, chloronicotinyls, for example acetamiprid, clothianidin, dinotefuran, imidacloprid, nitenpyram, nithiazine, thiacloprid, thiamethoxam, AKD-1022, imidaclotiz nicotine, bensultap, cartap; Acetylcholine Receptor Modulators for example, spinosyns, for example spinosad and spinetoram; GABA-controlled Chloride Channel Antagonists for example, organochlorines, for example camphechlor, chlordane, endosulfan, gamma-HCH, HCH, heptachlor, lindane, methoxychlor fiproles, for example acetoprole, ethiprole, fipronil, pyrafluprole, pyriprole, vaniliprole; Active Compounds with Unknown or Unspecific Mechanisms of Action, for example, aluminium phosphide, methyl bromide, sulphuryl fluoride antifeedants, for example cryolite, flonicamid, pymetrozine mite growth inhibitors, for example clofentezine, etoxazole, hexythiazox amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyridalyl, sulfluramid, tetradifon, tetrasul, triarathene, verbutin; Biologicals, Hormones or Pheromones for example, azadirachtin, Bacillus spec., Beauveria spec., codlemone, Metarrhizium spec., Paecilomyces spec., thuringiensin, and Verticillium spec.; Carboxamides, for example, flonicamid octopaminergic agonists, for example amitraz; Chitin Biosynthesis Inhibitors benzoylureas, for example bistrifluoron, chlofluazuron, diflubenzuron, fluazuron, flucycloxuron, flufenoxuron, hexaflumuron, lufenuron, novaluron, noviflumuron, penfluoron, teflubenzuron, triflumuron buprofezin cyromazine; Chloride Channel Activators mectins, for example abamectin, emamectin, emamectin-benzoate, ivermectin, lepimectin, milbemycin, latidectin, selamectin, doramectin, eprinomectin, moxidectin; Lipid Synthesis Inhibitors tetronic acids, for example spirodiclofen, spiromesifen tetramic acids, for example spirotetramat, cis-3-(2,5-dimethylphenyl)-4-hydroxy-8-methoxy-1-azaspiro-[4.5]dec-3-en-2-one; DNOC Site-I Electron Transport Inhibitors METIs, for example fenazaquin, fenpyroximate, pyrimidifen, pyridaben, tebufenpyrad, tolfenpyrad hydramethylnon dicofol; Ecdysone Agonists/Disruptors diacylhydrazines, for example chromafenozide, halofenozide, methoxyfenozide, tebufenozide; Inhibitors of Magnesium-stimulated ATPase, for example, propargite nereistoxin analogues, for example thiocyclam hydrogen oxalate, thiosultap-sodium; Latrophilin Receptor Agonists for example, depsipeptides, such as, for example, cycl. depsipeptide, for example, emodepside; Juvenile Hormone Mimetics, for example diofenolan, epofenonane, fenoxycarb, hydroprene, kinoprene, methoprene, pyriproxifen, triprene; Organophosphates, for example, acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-S-methyl, demeton-S-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion; Oxidative Phosphorylation Inhibitors, ATP Disruptors for example, diafenthiuron organotin compounds, for example azocyclotin, cyhexatin, fenbutatin-oxide; Oxidative Phosphorylation Decouplers (H-proton Gradient Interruptors), for example chlorfenapyr dinitrophenols, for example binapacryl, dinobuton, dinocap; Ryanodin receptor agonists benzoic acid dicarboxamides, for example flubendiamid anthranilamides, for example rynaxypyr (3-bromo-N-{4-chloro-2-methyl-6-[(methylamino)carbonyl]phenyl}-1-(3-chloropyridin-2-yl)-1H-pyrazole-5-carboxamide); Site-II Electron Transport Inhibitors for example, rotenone, Site-III Electron Transport Inhibitors for example, acequinocyl, fluacrypyrim, and Microbial Disruptors of the Insect Gut Membrane Bacillus thuringiensis strains; Sodium Channel Modulators/Voltage-dependent Sodium Channel Blockers, for example acrinathrin, allethrin (d-cis-trans, d-trans), beta-cyfluthrin, bifenthrin, bioallethrin, bioallethrin-S-cyclopentyl isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, deltamethrin, empenthrin (1R isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin OR isomer), tralomethrin, transfluthrin, ZXI 8901, pyrethrins (pyrethrum) DDT oxadiazines, for example indoxacarb semicarbazones, for example metaflumizone (BAS3201). Chitosan can be employed as the second component for insectide control. Such combination of first component and insecticide can be synergistic with regard to the combination of chemical constituents, and/or, synergistic with regard to ability of the first component and/or insecticide to improve and/or enhance the natural defenses of a plant against parasitic attack and/or stresses directly or indirectly caused by such parasitic attack.

Other combinations of actives can be used. In one aspect, the second component comprises a nematicide composition combined with or used sequentially with the first component. Suitable nematicide compositions include, for example, non-fumigant group nematicides and/or fumigant group nematicides. Examples of non-fumigant group nematicides include carbamates for example, Temik (aldicarb); Furadan (carbofuran); Vydate (oxamyl); benomyl, carbosulfan, cloethocarb, and Standak (aldoxycarb). Organophosphate nematicides such as, for example, diamidafos, fenamiphos, fosthietan, and phosphamidon. Organothiophosphate nematicides such as cadusafos, chlorpyrifos, dichlofenthion, dimethoate, ethoprophos, fensulfothion, fosthiazate, heterophos, isamidofos, isazofos, phorate, phosphocarb, terbufos, thionazin, and triazophos; Phosphonothioate nematicides such as imicyafos and mecarphon; Dasanit (fensulfothion); Mocap (ethoprop); Nemacur (pheamiphos); and others such as, for example, ClandoSan® (chitan/urea); DiTera® (fungal metabolite) and Avicta® (abamectin). Botanical nematicides such as carvacrol; Oxime carbamate nematicides such as alanycarb, aldicarb, aldoxycarb, oxamyl, tirpate, Avicta® (abamectin; Syngenta, LLC.), Gliocladium roseum, or chitosan can be employed as the second component. Such combination of first component and the nematicide listed above can be synergistic with regard to the combination of chemical constituents, and/or, synergistic with regard to ability of the first component and/or nematicide to improve and/or enhance the natural defenses of a plant against nematode attack and/or stresses directly or indirectly caused by such parasitic attack.

In another aspect, the first component is used together with an anti-viral agent, for example, agents that are effective for the control or remediation of asymptomatic viruses, protozoa, and parasitic plants in combination with the first component.

The optional component can also include growth regulators, for example, cytokinins, auxins, gibberellins, and combinations thereof with any of the compounds listed above.

The optional component can also comprise one or more plant macronutrients or plant micronutrients. The term “macronutrient” can refer to an element for plant growth, which is utilized by plants in proportionally larger amounts relative to micronutrients. The term “micronutrients” refers to an element utilized by plants during growth, which are used in smaller amounts relative to macronutrients. For example, plant macronutrients include nitrogen, potassium, phosphorus, calcium, magnesium and sulfur. The optional component can comprise various combinations and relative amounts of individual macronutrients. For example, plant micronutrients include iron, manganese, zinc, copper, boron, molybdenum and cobalt. Numerous compounds and substances are available to provide micronutrients as the optional component. Various combinations and relative amounts of micronutrients can be utilized in the optional component. The optional component can also include, in addition to any of the above, a mold inhibitor, an absorbent, a penetrant, and combinations thereof.

### Methods

Methods of use of the composition as described herein for controlling phytopathogenic fungus populations are further disclosed and provided. The phytopathogenic fungus can be an endoparasitic pest and/or an ectoparasitic pest. In one aspect, the methods described herein are specific to endoparasitic fungi in general. In other aspects, the methods described herein are specific to ectoparasitic fungi in general or both endoparasitic and ectoparasitic genera of fungi, inclusive of those of interest in causing damage to traditional agronomic plants.

In some embodiments, the composition is applied to an agricultural or horticultural seed, more especially a food crop. A “food crop” herein means a crop grown primarily for human consumption. Methods disclosed herein are appropriate both for immediately prior to sowing or for stored seed. The composition is not specific to a particular crop, as the first component is active to control the fungus. However, it may be that the first component works synergistically with the plant's defense system to control the fungus population, for example by toxicity and/or repelling.

While the present methods can be beneficial for gramineous (belonging to the grass family) crops such as cereal crops, including corn, wheat, barley, oats, rye, triticale, and rice, they are also highly appropriate for non-gramineous crops, including traditional agronomic crops, vegetable crops, fruit crops, oil-producing crops, and seed crops. The terms “fruit” and “vegetable” herein are used in their agricultural or culinary sense, not in a strict botanical sense; for example, tomatoes, cucumbers and zucchini are considered vegetables for present purposes, although botanically speaking it is the fruit of these crops that is consumed. Vegetable crops for which the present methods can be found useful include without limitation:

leafy and salad vegetables such as amaranth, beet greens, bitterleaf, bok choy, Brussels sprout, cabbage, catsear, celtuce, choukwee, Ceylon spinach, chicory, Chinese mallow, chrysanthemum leaf, corn salad, cress, dandelion, endive, epazote, fat hen, fiddlehead, fluted pumpkin, golden samphire, Good King Henry, ice plant, jambu, kai-lan, kale, komatsuna, kuka, Lagos bologi, land cress, lettuce, lizard's tail, melokhia, mizuna greens, mustard, Chinese cabbage, New Zealand spinach, orache, pea leaf, polk, radicchio, rocket (arugula), samphire, sea beet, seakale, Sierra Leone bologi, soko, sorrel, spinach, summer purslane, Swiss chard, tatsoi, turnip greens, watercress, water spinach, winter purslane and you choy;

flowering and fruiting vegetables such as acorn squash, Armenian cucumber, avocado, bell pepper, bitter melon, butternut squash, caigua, Cape gooseberry, cayenne pepper, chayote, chili pepper, cucumber, eggplant (aubergine), globe artichoke, luffa, Malabar gourd, parwal, pattypan squash, perennial cucumber, pumpkin, snake gourd, squash (marrow), sweetcorn, sweet pepper, tinda, tomato, tomatillo, winter melon, West Indian gherkin and zucchini (courgette);

podded vegetables (legumes) such as American groundnut, azuki bean, black bean, black-eyed pea, chickpea (garbanzo bean), drumstick, dolichos bean, fava bean (broad bean), French bean, guar, haricot bean, horse gram, Indian pea, kidney bean, lentil, lima bean, moth bean, mung bean, navy bean, okra, pea, peanut (groundnut), pigeon pea, pinto bean, rice bean, runner bean, soybean, tarwi, tepary bean, urad bean, velvet bean, winged bean and yardlong bean;

bulb and stem vegetables such as asparagus, cardoon, celeriac, celery, elephant garlic, fennel, garlic, kohlrabi, kurrat, leek, lotus root, nopal, onion, Prussian asparagus, shallot, Welsh onion and wild leek;

root and tuber vegetables, such as ahipa, arracacha, bamboo shoot, beetroot, black cumin, burdock, broadleaf arrowhead, camas, canna, carrot, cassava, Chinese artichoke, daikon, earthnut pea, elephant-foot yam, ensete, ginger, gobo, Hamburg parsley, horseradish, Jerusalem artichoke, jicama, parsnip, pignut, plectranthus, potato, prairie turnip, radish, rutabaga (swede), salsify, scorzonera, skirret, sweet potato, taro, ti, tigernut, turnip, ulluco, wasabi, water chestnut, yacon and yam; and

herbs, such as angelica, anise, basil, bergamot, caraway, cardamom, chamomile, chives, cilantro, coriander, dill, fennel, ginseng, jasmine, lavender, lemon balm, lemon basil, lemongrass, marjoram, mint, oregano, parsley, poppy, saffron, sage, star anise, tarragon, thyme, turmeric and vanilla.

Fruit crops for which the present methods can be found useful include without limitation apple, apricot, banana, blackberry, blackcurrant, blueberry, boysenberry, cantaloupe, cherry, citron, clementine, cranberry, damson, dragonfruit, fig, grape, grapefruit, greengage, gooseberry, guava, honeydew, jackfruit, key lime, kiwifruit, kumquat, lemon, lime, loganberry, longan, loquat, mandarin, mango, mangosteen, melon, muskmelon, olive, orange, papaya, peach, pear, persimmon, pineapple, plantain, plum, pomelo, prickly pear, quince, raspberry, redcurrant, starfruit, strawberry, tangelo, tangerine, tayberry, ugli fruit and watermelon.

Seed crops, for example, specialized crops used to produce seed of any plant species, for which the present methods can be found useful include, in addition to cereals (e.g., barley, corn (maize), millet, oats, rice, rye, sorghum (milo) and wheat), non-gramineous seed crops such as buckwheat, cotton, flaxseed (linseed), mustard, poppy, rapeseed (including canola), safflower, sesame and sunflower.

Other crops, not fitting any of the above categories, for which the present methods can be found useful include without limitation, sugar beet, sugar cane, hops, and tobacco.

Each of the crops listed above has its own particular fungus protection needs. Further optimization of compositions described herein for particular crops can readily be undertaken by those of skill in the art, based on the present disclosure, without undue experimentation.

Methods of using the compositions disclosed and described herein comprise applying a composition as described herein to a seed or plant, or to a locus of the seed or plant to control one or more fungus populations. The fungus population can be preexisting or can be one or more that is expected to develop, e.g., during storage of a material, the seed, or during the useful life of the material or plant. In one aspect, the compositions disclosed and described herein are applied to seeds, and/or applied to the soil either before during or after sowing, and/or applied to the foliage or any part of the emerged plant. Sequential treatments, e.g., seed treatment followed by soil and/or foliar treatments, such treatments separated by a period of time, can be employed.

Compositions disclosed and described herein can be provided in concentrate form, (e.g., liquid, gel, or reconstitutable powder form), suitable for further dilution and/or mixing in water prior to application to the seed, plant, or locus. Alternatively, they can be provided as a ready-to-use solution or suspension for direct application. Because compositions disclosed and described herein can be combined with other Al's, such as fertilizer solutions and/or with pesticide solutions, they can be diluted and/or reconstituted by mixing with such other solutions. The above concentrate compositions are suitable for further dilution. Thus, in one aspect, the composition comprises the first component, suitably formulated for application to a plant, a single seed or to an assemblage of seeds in bulk or in a continuous process, or the locus of the plant or seed after sowing, the first component present in an amount sufficient to control the population of fungus on the plant or seed or in the loci of the plant or seed.

### Seed, Foliage, and Locus Treatments or Coatings

Compositions disclosed and described herein useful for phytopathogenic fungus population control can be applied using any conventional system for applying liquids to foliage, seed, or locus. Most commonly, for seed, application is by tumbling the seed with a liquid, gel, oil/water emulsion, or powder form of the composition, which can be introduced to the seed by spraying for example, will be found most convenient. For spraying, any conventional atomization method can be used to generate spray droplets, including hydraulic nozzles and rotating disk atomizers combined with the tumbler.

In one aspect, methods for fungus population control is provided that comprises contacting the seeds with an aqueous composition comprising the first component and an optional component selected from one or more pesticides and/or one or more natural plant hormones. The seeds may be contacted with the composition by conventional means such as spraying, rolling, or tumbling in a continuous or batch-treating process. Thus, the first component can be combined with an optional component. Combinations of the first component and the optional component can be mixed in aqueous media at a concentration, and brought into contact with the seeds for a time sufficient to provide for fungus population control prior to sowing and/or in the intended locus of planting.

For seed treatment or seed coatings, the amount of (application rate) the first component can be about 0.1 mL/100 kg seed weight to about 1000 mL/100 kg seed weight. Other concentrations of the compositions disclosed herein can be used. In certain aspects, the application rate can be between about 1 mL/100 kg seed to about 100 mL/100 kg seed; preferably about 10 mL/100 kg seed to about 75 mL/100 kg seed.

For foliage surface or locus applications, the application rate of the compositions disclosed herein can be between about 0.01 gram/hectare to about 10.0 gram/hectare dry weight, between about 0.2 gram/hectare to about 2.0 gram/hectare dry weight, between 0.3 gram/hectare to about 1.5 gram/hectare dry weight, or between about 0.4 gram/hectare to about 1.0 gram/hectare dry weight applied in the soil or as a foliar application to the foliage or the locus of the plant. Other concentrations of the compositions disclosed herein can be used. In one aspect, absorption of the applied composition typically occurs at the site of application on a foliar surface, but the applied composition can run down to other areas and be absorbed there. Runoff (where an applied solution is shed from foliar surfaces and reaches the soil or other growing medium of the plant) is generally undesirable, but the applied first component is generally not totally lost as it can be absorbed by the plant's root system anytime during the expected life of the plant. However, methods of application that minimize runoff are preferred, and are well known to those of skill in the art.

Application solutions prepared by using (or diluting) concentrate compositions as described above represent further aspects of the compositions and methods disclosed and described herein.

For seed treatment applications, a concentrate composition of the first component can be used or diluted up to about 600-fold or more with water, more typically up to about 100-fold or up to about 40-fold. Illustratively, a concentrate product can be applied at about 0.01 mg/Kg seed to about 10 mg/Kg seed, for example about 0.1 mg/Kg seed, 0.5 mg/Kg seed, 2.5 mg/Kg seed or a higher amount. Other concentrations of the compositions disclosed herein can be used

For application to plant foliage, a concentrate composition can be diluted up to about 600-fold or more with water, more typically up to about 100-fold or up to about 40-fold. Illustratively, a concentrate product can be applied at about 0.1 to about 30 liter/hectare (1/ha), for example about 5 to about 25 1/ha, in a total application volume after dilution of about 60 to about 600 l/ha, for example about 80 to about 400 1/ha or about 100 to about 200 l/ha. Other concentrations of the concentrate compositions disclosed herein can be used

For seed treatment applications, a concentrate composition of the first component can be used or diluted up to about 600-fold or more with water, more typically up to about 100-fold or up to about 40-fold. Illustratively, a concentrate product can be applied at about 0.1 mg/Kg seed to about 100 mg/Kg seed, for example about 0.1 mg/Kg seed, 1 mg/Kg seed, 10 mg/Kg seed. Other concentrations of the concentrate compositions disclosed herein can be used

The compositions disclosed herein can be applied in a sequential order, for example, the seeds, plant, or its locus can be contacted with the first component, and optionally at least one pesticide and the post-emergent plant or its locus can be contacted with the first component and optionally at least one pesticide. The frequency of an application and rate of the compositions disclosed and described herein can be varied depending on many factors. It may be advantageous to apply a relatively high rate, followed by one or more subsequent applications at the same or at a lower rate. Application frequency can be, for example, a single application up to three applications per season. In certain situations, a single application will suffice. In other situations, the first and/or second and/or third application may precede, supersede, or correspond to a particular growth cycle of the plant, or a known life cycle or endemic habit of the fungus.

In another aspect, methods of controlling phytopathogenic fungus populations are provided that comprises applying to the seeds, plants, or locus a coating or dressing of a polymer or other matrix, the polymer or matrix comprising the first component, optionally one or more pesticides and/or one or more natural plant hormones. The polymer or matrix is capable of releasing the first component and, optionally one or more pesticides and/or one or more natural plant hormones (collectively, “the actives”). The polymer or matrix can be designed to release the actives in response to temperature, moisture content, sunlight, time, or combinations thereof. The polymer or matrix can quickly dissolve or disintegrate releasing the actives or can controllable release the actives over time or in response to a predetermined condition such as temperature, moisture content, sunlight, time, or combinations thereof. The polymer or matrix can be multi-layer, with discrete layers, for example, for disrupting the coating to allow moisture ingress, housing the actives, etc. Suitable polymers or matrixes include hydrogels, microgels, or sol-gels. Specific materials (including complete formulations) and methods of coatings seeds useful in this regard include such process and materials as used, for example, Intellicoat™ (Landec Inc., Indiana); ThermoSeed™ (Incotec, Netherlands) CelPril™ Poncho™, Poncho/VOTiVo™ (Bayer CropScience); ApronMaxx™ (Syngenta); and Nacret™ (Syngenta). The actives can be provided as nanoparticles and incorporated into the polymer or matrix, or directly adhered to the seed coat. The thickness of the polymer or matrix coating may be between from about 0.01 mils to about 10 mils in thickness. The coating can further provide protection for the seeds from mechanical and environmental damages and can facilitate the drilling process. Live and dead seeds of the same or different plant can be coated, dressed, and/or encrusted with the first component and optionally other components for co-planting, pre-planting, or used in parallel or sequentially.

For seed treatment or seed coatings as described above, the amount of the first component can be about 0.01 mg/kg seed weight to about 10 mg/kg seed weight, however, higher rates can be employed.

### Compositions for Phytopathogenic Fungi Population Control

Controlling phytopathogenic fungus populations at the locus of a seed and or plant will improve one or more of nodulation, germination, root development, emergence, and health, particularly resistance to or protection from disease, especially bacterial or fungal disease, which is an important benefit of the methods disclosed and described herein. Methods as described in detail above are useful for controlling phytopathogenic fungus populations, which provide improved general plant health, nutrition and/or improved agronomical benefit of a plant and/or seed. Any benefit related to phytopathogenic fungus population control, such as for example, reduction in total number/area of phytopathogenic fungus, reduction in phytopathogenic fungus spores, and/or reduction in damage to the plant, can be an agronomical benefit of the present methods. Secondary benefits of controlling the nematode population include, without limitation, improved root development (e.g., improved root or root hair growth), higher quality produce, improved growth and/or a longer growing season (which in either case can lead to higher yield of produce), faster emergence, improved plant stress management including increased stress tolerance and/or improved recovery from stress, increased mechanical strength, improved drought resistance, and reduced casual fungal disease infection. Combinations of any of these benefits can be obtained.

### Trial 1. Efficacy for Fungus-Like (Oomycete) Control in Bell Peppers-Soil Application

Phytophthora capasici control—The objective of Trial 1 was to verify or confirm efficacy of the first component for the control of Phytophthora capasici using Bell peppers as the subject host for the oomycete. Growth ratings for plant development, along with early and late season fruit development and final production were collected for this trial. Disease development data for Phytophthora capsici was collected for this test. The pepper plants were also inspected for any application phytototoxic effects after the initial application of the first component at various application rates.

Trial 1 was configured as a strip trial utilizing four replications for each treatment and for data collecting. Trial 1 accommodated the first component for injection in an exemplary installed surface drip irrigation system. Each replicate consisted of one bed (3.33 feet wide) by 1300 feet in length. Each bed contained two lines of Bell pepper plants. All applications were made utilizing a hypro pump with a manifold to distribute the products to the drip tape during a normal irrigation period for the crop. Data representing early season harvest and final harvest data, respectively, was collected. When harvesting, four plants per replicate were utilized, with all peppers being harvested and segregated as marketable, not ready for harvest, or culls due to fungus disease. The total weight, the total number, and the average weight per fruit data were collected. The final harvest data was also extrapolated out to a ton per acre estimated yield. During the early plant development phase of Trial 1 the beginnings of a Phytophthora capasici infection were noted in the field at 38 days after planting. It appeared that this disease was more prevalent in the untreated check when compared to the first component treatments. While data obtained in a first part of the field show the P. capsici population building at the border, later data taken for the length of the field was more representative of the true severity of this disease during the Trial. On the last rating day at 93 days after planting, the P. capsici incidence was significantly (about 30%) less in the plots treated with the first component when compared to the untreated check. No phytotoxic effects were observed from the first component at the application rates tested.

Trial 2—Efficacy of First Component Control of Botryosphaeria obtusa (Frogeye Leaf Spot/Black Rot) and Colletotrichum truncatum (Anthracnose) on Soybean—Foliar Treatment.

Trial 2 objective included the determination of the efficacy of the first component in controlling various fungus populations on soybean using the first component compared to industry standard fungicide treatment (STRATEGO™) verses untreated control. First component with Stratego, and Stratego alone were tested on AG 4703 variety soybean. Application rates were 6 oz/ac for the first component, combined amounts of first component at 6 oz/ac with 10 oz/ac Stratego, or 10 oz/ac Stratego alone. This trial demonstrated that the combination of the first component and Stratego was significantly better in controlling anthracnose than the Stratego alone. This trial also had a significant incidence of Frogeye Leaf Spot (FLS) and the first component with Stratego, as well as Stratego alone, provided significant disease control. There was a small improvement in FLS control with the first component and Stratego compared to Stratego alone. In addition, this combination had numerically the greatest yield for the soybean grown, which was not significantly different than the Stratego alone. This trial demonstrated synergy between the first component and a conventional fungicide.

Trial 3—Efficacy of First Component for Control of Fusarium solani for Cucumber—Seed Treatment

In Trial 3 the first component was contacted with cucumber seed (Cucumis sativus) via a lab batch seed treater using concentrations of 13 ml/100 kg seed, 26 ml/100 kg seed, and 52 ml/100 kg seed. Industry standards were used, namely, Maxim™ 4FS at 10 ml/100 kg of seed. Untreated controls were used, with and without inoculation with F. solani. F. solani noculum used was grown on 2× autoclaved rice for 10 days, screened through a tea screener, concentrated and added to the soil system at a rate of 0.5% w/v. Additional inoculum added at 500,000 macro conidia added to the base of the plant at 1 ml per plant at time of inoculation. Inoculum grown on standard PDA and harvested via distilled water just prior to application.

For Trial 3, emergence and disease severity were evaluated for the first component compared to an industry standard treatment, un-innoculated-not treated and inoculated-not treated controls. Disease ratings for F. solani were determined based on a scale of 0-5, being no symptoms, slight disease (stunting); moderate disease (stunting, water soaked lesions); moderate to severe disease (stunting, lesions, slight wilting), severe disease (wilting); plant death, respectively, and was evaluated after 2, 3 and 4 weeks. Emergence for most treatments were consistently lower in all compared to the untreated, uninoculated control where 100% of plants (2 plants per pot) emerged. Disease development began at 10-14 days after emergence and progressed steadily, consequently, no emergence data were evaluated after the second week. ANOVA was performed on each emergence data set. For mean separation, the Newman-Keuls multiple comparison test and Dunnett's multiple comparison to a control test were utilized. Trial 3 demonstrated no significant observed differences in emergence of the cucumber seedlings, however, significant and highly progressive disease was observed around the soil line/crown of the seedlings beginning at roughly two weeks from plantings. Symptoms were water soaked, orange colored lesions very typical of F. solani. Because of the progression of the disease, no evaluations were made on roots or stems. Based on these data, Trial 3 indicated that the Maxim™ alone or in combination with the first component was slightly superior in its potential for controlling F. solani on cucumbers at the tested level of inoculum application, however, the first component alone demonstrated little effect in on controlling F. solani with the application rates tested. No phytotoxicity was noted with any of the materials.

### Trial 4—Efficacy of First Component for Control of Pythium Aphanidermatum for Soybean—Seed Treatment

In Trial 4 the first component was contacted with Amor 47F8 soybean seed (Glycine max) via a lab batch seed treater using concentrations of 13 ml/100 kg seed, 26 ml/100 kg seed, and 52 ml/100 kg seed. Industry standards were used, namely, Maxim™ 4FS at 10 ml/100 kg of seed. Untreated controls were used, with and without inoculation with Pythium. Pythium noculum used was grown on 2× autoclaved rice for 10 days, screened through a tea screener, concentrated and added to the soil system at a rate of 0.5% w/v.

For Trial 4, emergence and disease severity were evaluated for the first component compared to an industry standard treatment (Trilex™ 2000), un-innoculated-not treated and inoculated-not treated controls. Disease ratings for Pythium were determined based on a scale of 0-5, being no symptoms, slight disease (stunting); moderate disease (stunting, water soaked lesions); moderate to severe disease (stunting, lesions, slight wilting), severe disease (wilting); plant death, respectively, and was evaluated after 2, 3 and 4 weeks. Emergence for most treatments were consistently lower in all compared to the untreated, uninoculated control where 100% of plants (2 plants per pot) emerged. In the late emergence, the untreated, inoculated control had some post-emergence damping off and was significantly different (P=0.05) compared to the untreated/uninoculated control. At the end of the test, soybean roots were excised uniformly above the crown and carefully washed in water to remove soil. Roots were air dried for approximately 1 hour and weighed. No real differences in weights were noted between surviving plants/treatments overall. ANOVA was performed on each emergence data set. For mean separation, the Newman-Keuls multiple comparison test and Dunnett's multiple comparison to a control test were utilized. Trial 4 demonstrated the untreated/inoculated treatment had significantly more disease compared to the untreated/uninoculated control or the samples treated with the first component.

Based on these data, Trial 4 indicated that all of the first component treatments had a positive effect in controlling Pythium on soybean seedlings with the first component being comparable with the industry standard (Trilex™ 2000). Based on these data, Trial 4 indicated that the Trilex™ alone or in combination with the first component was slightly superior in its potential for controlling Pythium on soybeans at the tested level of inoculum application. No phytotoxicity was noted with any of the application rates of the first component.

### Trial 5—Efficacy of First Component for Control of Powdery Mildew (e.g., Erysiphe spp., Sphaerotheca spp.) for Pumpkins—Combined-Fertilizer Granule Treatment

Trial 5 objectives were to determine efficacy of control of powdery mildew disease in pumpkins using the first component in combination with fertilizer at both preplant and sidedress applications.

Control pumpkin plants had 400 lbs/acre of 12-12-12 fertilizer applied with 300 lbs/acre of 15.5-0-0 sidedressed. Test samples included pumpkin preplant applications of 400 lbs/acre of 12-12-12 fertilizer impregnated with 8 oz/acre of first component on preplant fertilizer. Sidedress of the test samples included 300 lbs/acre of 15.5-0-0 impregnated with 8 oz/acre of first component. The first component, as an addition to a standard pumpkin fertility program, while providing a slight influence on pumpkin growth, provided certain disease, growth and yield parameters improvement. Trial 5 data indicated that the amount of foliar powdery mildew disease was lowest in the first component samples—preplant and sidedress treatment, compared to all others evaluated during this trial.

Trial 6—Efficacy of First Component for Control of Rhizoctonia solani in Seedling Cotton—Seed Coating

In Trial 6 the first component was contacted with Phytogen 375 WNR cotton seedling (Gossypium hirsutum) via a lab batch seed treater using concentrations of 13 ml/100 kg seed, 26 ml/100 kg seed, and 52 ml/100 kg seed. Industry standards were used, namely, Maxim™ 4FS at 10 ml/100 kg of seed. Untreated controls were used, with and without inoculation with R. solani. R. solani noculum used was grown on 2× autoclaved rice for 10 days, screened through a tea screener, concentrated and added to the soil system at a rate of 0.5% w/v.

For Trial 6, emergence and disease severity were evaluated for the first component compared to an industry standard treatment (Trilex™ 2000), un-innoculated-not treated and inoculated-not treated controls. Disease ratings for R. solani were determined based on a scale of 0-5, being no symptoms, slight disease (stunting); moderate disease (stunting, water soaked lesions); moderate to severe disease (stunting, lesions, slight wilting), severe disease (wilting); plant death, respectively, and was evaluated after 2, 3 and 4 weeks. At early emergence, the untreated, uninoculated check was significant compared to some of the other treatments. As the test extended, more cotton emerged in other treatments eliminating the significance. It is unclear if the R. solani slowed emergence and/or the first component had a slight, reversable phytotoxic effect on germination and plant development. Because inoculant controls were not treated and the R. solani manifested into significant disease development later, the pathogen, most likely, was the cause of the delayed emergence and slower plant development. At the end of the test, cotton whole plants were removed and carefully washed in water to remove soil. Plants were air dried for approximately 1 hour and weighed (whole plants). In this test, no real differences in weights were noted between surviving plants/treatments overall. ANOVA was performed on each emergence data set. For mean separation, the Newman-Keuls multiple comparison test and Dunnett's multiple comparison to a control test were utilized. Trial 6 demonstrated the untreated/inoculated treatment had significantly more disease compared to the untreated/uninoculated control or the samples treated with the first component, or the industry standard. Significant differences were observed at early emergence and per disease severity. Disease was very typical of R. solani with deep, water soaked lesions developing at the soil line/crown of seedlings and encircling the stem. Roots were unaffected in terms of lesion development though severe disease resulted in less root mass overall. Because disease was distinctly different between the uninoculated control (TRT 1) and the inoculated control (TRT 2), the first component is believed to provide a controlling effect on R. solani. There was observed less disease control with the lower rate of first component (though not statistically significant) in comparison to the industry standard Trilex-treated seeds.

Based on these data, Trial 6 indicated that all of the first component treatments had a positive effect in controlling R. solani on cotton seedlings with the first component being comparable with the industry standard (Trilex™ 2000). Based on these data, Trial 4 indicated that the Trilex™ alone or in combination with the first component was slightly superior in its potential for controlling R. solani on cotton at the tested level of inoculum application. No phytotoxicity was noted with any of the application rates of the first component.

The above seed/soil/foliar treatments indicate the first component is an effective phytopathogenic fungus population control active across a broad spectrum of fungi and fungus-like species. As the first component is relatively stable to environmental conditions, a soil and/or foliar treatment would yield comparable results, and could be combined with seed treatment if desired. Thus, a method for controlling a population of phytopathogenic fungus in the general locus of a plant or seed is achieved by contacting the loci or seed or plant with the first component and optionally a second component in an amount that controls the phytopathogenic fungus population of the loci, for example, by the observable improvement in the germination, emergence, root development or vigor of the seed or plant as compared to a seed or loci not contacted with the composition disclosed herein. The above data clearly demonstrates the use of the DOM of a defined composition as disclosed herein for reducing or eliminating damage to a seed or plant caused directly or indirectly from a phytopathogenic fungus. In addition, above data clearly demonstrates the use of DOM that is essentially metal-cation free such that the use thereof disrupts one or more metal cation-dependent biological pathways of the fungus.

All patents and publications cited herein are incorporated by reference into this application in their entirety. The words “comprise”, “comprises”, and “comprising” are to be interpreted inclusively rather than exclusively.

1. A method for management of phytopathogenic fungus or fungus-like organism on a seed, plant, or locus of a seed or a plant, the method comprising:
preparing a seed with, or introducing to a plant or its locus, an amount of first component comprising dissolved organic matter (DOM) concentrate of defined composition, the DOM characterized by at least two of:
a mixture of condensed hydrocarbons, lignins, and tannins and/or condensed tannins, and one or more trace metals;
an oxygen-to-carbon ratio for the dissolved organic matter of greater than about 0.5;
a total number of tannin compounds greater than about 200, the tannin compounds having a hydrogen to carbon ration of about 0.5 to about 1.4, and an aromaticity index of less than about 0.7 as measured by mass spectroscopy; or
a percent mass distribution of about 47-56 percent lignin compounds, 33-42 percent tannin compounds, and about 8-11 percent condensed hydrocarbon as measured by mass spectroscopy;
reducing or eliminating damage to the seed or plant caused directly or indirectly from the phytopathogenic fungus.

2. The method of claim 1, wherein the DOM is a mixture of condensed hydrocarbons, lignins, and tannins and/or condensed tannins, characterized in that at least 20 percent of the total percent of compounds of the composition are tannins and/or condensed tannins.

3. The method of claim 1, wherein the DOM is characterized by comprising a mixture of condensed hydrocarbons, lignins, and tannins and/or condensed tannins, characterized in that at least 10 percent of the total percent of compounds of the composition are tannins and/or condensed tannins.

4. The method of claim 1, wherein the phytopathogenic fungus or the fungus-like organism is an endoparasitic pest and/or an ectoparasitic pest.

5. The method claim 1, wherein the phytopathogenic fungus or the fungus-like organism is selected from Ascomycetes, Deuteromycetes, Basidiomycetes, and Oomycetes.

6. The method of claim 1, where the seed is cotton and the phytopathogenic fungus or the fungus-like organism is Rhizoctonia solani.

7. The method of claim 1, where the seed is soybean and the phytopathogenic fungus or the fungus-like organism is Pythium Aphanidermatum.

8. The method of claim 1, wherein the first component is releasably contained in a polymer matrix, the polymer matrix configurable for seed coating, seed dressing, seed encrusting, fertilizer granule or fertilizer powder.

9. The method of claim 1, wherein the first component is used in combination with at least one of an insecticide, attractant, sterilizing agent, bactericide, acaricide, nematicide, additional fungicide, growth-regulating substance, herbicide, safener, fertilizer, and/or semiochemical.

10. The method of claim 9, wherein the first component and the at least one of an insecticide, attractant, sterilizing agent, bactericide, acaricide, nematicide, additional fungicide, growth-regulating substance, herbicide, safener, fertilizer, semiochemical, and combinations thereof are releasably contained in a polymer matrix, the polymer matrix configurable for seed coating, seed dressing, seed encrusting, fertilizer granule or fertilizer powder.

11. The method of claim 1, further comprising extender, liquid solvent, solid carrier, surfactant, emulsifier, dispersant, tackifier, and/or colorant.

12. The method of 9, where the first component is used in combination with the additional fungicide and the fungus or the fungus-like organism is Fusarium solani.

13. The method of claim 1, wherein the phytopathogenic fungus or the fungus-like organism is Alternaria (A. solani, A. alternate); Aphanomyces; Ascochyta; Bipolaris Drechslera (D. maydis); Blumeria graminis; Botrytis cinerea; Bremia lactucae; Cercospora; Cochliobolus (C. sativus, C. miyabeanus); Colletotricum; Drechslera (D. teres, D. tritici-repentis); Pyrenophora; Esca; Exserohilum; Erysiphe cichoracearum; Sphaerotheca fuliginea; Verticillium; Fusarium (F. graminearum, F. culmorum, F. oxysporum); Gaeumanomyces graminis; Gibberella (G. fujikuroi); Helminthosporium; Michrodochium nivale; Mycosphaerella (M. graminicola, M. fijiensis); Peronospora (P. brassicae, P. destructor); Phakopsara pachyrhizi Phakopsara meibomiae; Phomopsis; Phytophthora (P. infestans); Phytophthora (P. capsici); Plasmopara viticola; Podosphaera leucotricha; Pseudocercosporella herpotrichoides; Pseudoperonospora (P. cubensis, P. humili); Puccinia (P. triticina, P. striformins, P. hordei, P. graminis, P. asparagi); Pyricularia oryzae, Corticium sasakii, Sarocladium (S. oryzae, S. attenuatum), Entyloma oryzae; Pyricularia grisea; Pythium (P. ultiumum, P. aphanidermatum); Rhizoctonia (R. solani); Rhynchosporium secali; Sclerotinia; Septoria tritici; Stagonospora nodorum; Erysiphe (Uncinula) necator; Setospaeria; Sphacelotheca reilinia; Thievaliopsis; Tilletia; Ustilago (U. maydis); or Venturia (V. inaequalis).

14. The method of claim 8, where the phytopathogenic fungus or fungus-like organism is Oomycete.

15. The method of claim 1, where the phytopathogenic fungus or fungus-like organism is Phytophthora capasici.

16. The method of claim 1, where the phytopathogenic fungus or fungus-like organism is Phakopsora pachyrhizi, Phakopsora meibomiae (Asian Rust), Botryosphaeria obtusa (Frogeye leaf spot/Black Rot), and Colletotrichum truncatum (Anthracnose).

17. The method of claim 1, where the phytopathogenic fungus or fungus-like organism is Pythium Aphanidermatum.

18. The method of claim 1, where the phytopathogenic fungus or fungus-like organism is Erysiphe spp. or Sphaerotheca spp.

19. The method of claim 1, where the phytopathogenic fungus or fungus-like organism is Rhizoctonia solani.

20. The method of claim 1, where the seed is cotton and the phytopathogenic fungus or fungus-like organism is Rhizoctonia solani.

21. The method of claim 1, where the seed is soybean and the phytopathogenic fungus or fungus-like organism is Pythium Aphanidermatum.

22. The method of claim 1, wherein the introduction of the first component is to a locus of plant cotton and the phytopathogenic fungus or fungus-like organism is Phytophthora capasici.

23. The method of claim 1, wherein the introduction of the first component is to a fertilizer and the phytopathogenic fungus or fungus-like organism is Erysiphe spp. or Sphaerotheca spp. (Powdery Mildew).

24. The method of claim 1, where the plant or the seed is of a legume crop, is of a fruit or vegetable crop, is of a grain or oil seed crop; is selected from grains, grasses, oil seed, agronomic crops, or brassica, or is genetically modified.

25. (canceled)

26. (canceled)

27. (canceled)

28. (canceled)

29. The method of claim 1, wherein the first component is introduced to a fertilizer, the fertilizer being a granule or powder.

30. A method of controlling a fungus a fungus-like organism, or a yeast in an environment, the method comprising:
introducing to the environment an amount of a first component comprising essentially metal cation free dissolved organic matter (DOM) concentrate, the DOM characterized by at least two of:
a mixture of condensed hydrocarbons, lignins, and tannins and/or condensed tannins, and one or more trace metals;
an oxygen-to-carbon ratio for the dissolved organic matter of greater than about 0.5;
a total number of tannin compounds greater than about 200, the tannin compounds having a hydrogen to carbon ration of about 0.5 to about 1.4, and an aromaticity index of less than about 0.7 as measured by mass spectroscopy, or
a percent mass distribution of about 47-56 percent lignin compounds, 33-42 percent tannin compounds, and about 8-11 percent condensed hydrocarbon as measured by mass spectroscopy;
disrupting one or more metal cation-dependent biological pathways of the fungus, a fungus-like organism, or yeast; and
reducing or eliminating damage to a seed or a plant caused directly or indirectly from the fungus, the fungus-like organism, or the yeast.

31. The method of claim 30, wherein the DOM is a mixture of condensed hydrocarbons, lignins, and tannins and/or condensed tannins, characterized in that at least 20 percent of the total percent of compounds of the composition are tannins and/or condensed tannins.

32. The method of a claim 30, wherein the DOM is characterized by comprising a mixture of condensed hydrocarbons, lignins, and tannins and/or condensed tannins, characterized in that at least 10 percent of the total percent of compounds of the composition are tannins and/or condensed tannins.

33. The method of any of claim 1, further comprising the step of substantially avoiding disrupting ectomycorrhizae and endomycorrhizae mycorrhizal associations of the seed and/or plant.

34. The method of claim 33, wherein mycorrhizal associations include vesicular arbuscular (VA) mycorrhizae.

35. (canceled)

36. (canceled)

37. (canceled)

38. (canceled)
